(19) United States
(12) Patent Application Publication
(10) Pub. No.: US 2009/0161223 A1
(43) Pub. Date: Jun. 25, 2009

(54) Anti-reflection layer with nano particles

(76) Inventors: Hirotoschi Ichikawa, Tokyo (JP); Yoshiaki Horikawa, Tokyo (JP); Fusao Ishii, Menlo Park, CA (US)

Correspondence Address: Bo-In Lin, 13445 Mandoli Drive, Los Altos Hills, CA, 94022, US

(21) Appl. No.: 12/072,449

(22) Filed: Feb. 25, 2008

Related U.S. Application Data
(60) Provisional application No. 60/903,463, filed on Feb. 26, 2007.

(51) Int. Cl. G02B 1/11

(52) U.S. Cl. 359/601

(57) ABSTRACT

A micromirror device includes a particle-containing anti-reflection layer that covers at least a portion of the device or its package other than a mirror surface. The size of the particle may be smaller than or equal to the wavelength of light incident on the micromirror device, or smaller than or equal to 800 nm, preferably at least 380 nm but smaller than or equal to 800 nm. The particles may be metal particles, preferably TiN particles.

This application is a Non-provisional application claiming a Priority date of Feb. 26, 2007 based on a previously filed Provisional Application 60/903,463 filed by the common Applicants of this application and the disclosures made in Provisional Application 60/903,463 are further incorporated by reference.

### BACKGROUND OF THE INVENTION

1. Field of the Invention

The present invention relates to a micromirror device with a plurality of mirrors. More particularly, the present invention relates to a micromirror device in which unwanted incident light on portions of the device other than the mirror surfaces is absorbed by an anti-reflection layer with nano particles to improve the quality of a projected image.

2. Prior Art

The image display systems implemented with micromirror devices a spatial light modulator (SLM) are still confronted with a technical difficulty that there are “unwanted” lights diffracted not directly from the micromirrors but from areas between the micromirrors. These unwanted lights degrade the quality of the displayed images. Furthermore, there are no cost-effective techniques to manufacture anti-reflective coating on these devices to absorb the light that is not reflected by the micromirrors. In order to better understand the technical difficulties, a brief overview of the general composition and operation of micromirror devices will follow.

Referring to FIG. 1A for an image display system 41 including a screen 42 is disclosed in a reference U.S. Pat. No. 5,214,420. A light source 50 is used for generating light energy for illuminating the screen 42. The generated light 49 is further collimated and directed toward a lens 52 by a mirror 51. Lenses 52, 53 and 54 form a beam columnator operative to columnate light 49 into a column of light 48. A spatial light modulator (SLM) 55 is controlled on the basis of data input by a computer 59 via a bus 58 and selectively redirects the portions of light from a path 47 toward an enlarger lens 45 and onto screen 42. The SLM 55 has a mirror array including switchable reflective elements 57, 67, 77, and 87 each comprising a mirror 73 connected by a hinge 70 and supported on a surface 56 of a substrate in the electromechanical mirror device as shown in FIG. 1B. When the element 57 is in one position, a portion of the light from the path 47 is redirected along a path 46 to lens 45 where it is enlarged or spread along the path 44 to impinge on the screen 42 so as to form an illuminated pixel 43. When the element 57 is in another position, the light is redirected away from the display screen 42 and hence the pixel 43 is dark.

Most of the conventional image display devices such as the devices disclosed in U.S. Pat. No. 5,214,420 are implemented with a dual-state mirror control that controls the mirrors to operate at a state of either ON or OFF. The quality of an image display is limited due to the limited number of gray scales. Specifically, in a conventional control circuit that applies a PWM (Pulse Width Modulation), the quality of the image is limited by the LSB (least significant bit) or the least pulse width as controlled by the ON or OFF state. Since the mirror is controlled to operate in an either ON or OFF state, the conventional image display apparatuses have no way to provide a pulse width to control the mirror that is shorter than the control duration allowable according to the LSB. The least quantity of light, which determines the least amount of adjustable brightness for adjusting the gray scale, is the light reflected during the time duration according to the least pulse width. The limited gray scale due to the LSB limitation leads to a degradation of the quality of the display image.

Specifically, FIG. 1C exemplifies a control circuit for controlling a mirror element according to the disclosure in the U.S. Pat. No. 5,285,407. The control circuit includes a memory cell 72. Various transistors are referred to as “M*” where “*” designates a transistor number, and each transistor is an insulated gate field effect transistor. Transistors M5 and M7 are p-channel transistors; while transistors M6, M8, and M9 are n-channel transistors. The capacitances C1 and C2 represent the capacitive loads in the memory cell 72. The memory cell 72 includes an access switch transistor M9 and a latch 72a, which is based on a Static Random Access switch Memory (SRAM) design. The transistor M9 connected to a Row-line receives a DATA signal via a Bit-line. The memory cell 72-written data is accessed when the transistor M9 that has received the ROW signal on a Word-line is turned on. The latch 72a includes two cross-coupled inverters, i.e., M5/M6 and M7/M8, which permit two stable states, that is, a state 1 is Node A high and Node B low, and a state 2 is Node A low and Node B high.

FIG. 1D shows the “binary time periods” in the case of controlling SLM by four-bit words. As shown in FIG. 1D, the time periods have relative values of 1, 2, 4, and 8 that in turn determine the relative quantity of light of each of the four bits, where the “1” is least significant bit (LSB) and the “8” is the most significant bit. According to the PWM control mechanism, the minimum quantity of light that determines the resolution of the gray scale is a brightness controlled by using the “least significant bit” for holding the mirror at an ON position during a shortest controllable length of time.

In a simple example with n bits word for controlling the gray scale, one frame of display time is divided into (2ⁿ−1) equal time slices. If one frame of display time is 16.7 msec., each time slice is 16.7/(2ⁿ−1) msec.

What follows is a description of the configuration and operation of a sample micromirror device.

FIG. 2 depicts a micromirror device 10 having a plurality of mirror elements 1 arranged in a two-dimensional manner on a semiconductor wafer substrate 11. Although FIG. 2 shows only 16 mirror elements 1, an actual micromirror device 10 typically has a larger number of mirror elements 1.

As shown in FIG. 2, the micromirror device 10 is configured in such a way that a plurality of mirror elements 1 are arranged horizontally and vertically in the two-dimensional plane of the semiconductor wafer substrate 11, each of the mirror elements 1 having an elastic hinge (not shown), a mirror 16 supported by the elastic hinge, and an address electrode (not shown) for driving the mirror 16.

In a typical micromirror device, each of the mirror elements 1 has two address electrodes to control one mirror 16. FIG. 2 also shows broken lines, each indicating a deflection axis 2 around which the surface of the mirror 16 is deflected.

The configuration of the mirror element 1 will be described with reference to FIGS. 3A and 3B, each of which is a cross-sectional view of the mirror element 1 taken along the line II-II shown in FIG. 2.

In FIGS. 3A and 3B, two address electrodes 3 and 5 for driving the mirror 16 are provided on the semiconductor wafer substrate 11, including a drive circuit (not shown) for driving the mirror 16. The mirror 16 is supported above the address electrodes 3 and 5 by an elastic hinge 13 that stands on the semiconductor wafer substrate 11.

The elastic hinge 13 is connected to a grounded hinge electrode 4. The address electrodes 3 and 5 are electrically connected to the drive circuit (not shown) in the semiconductor wafer substrate 11. When the address electrodes 3 and 5 receive control signals, an electrical potential difference is generated between the two address electrodes 3, 5 and the mirror 16, and the resultant electrostatic force controls the deflection direction of the mirror 16. Each of the address electrodes 3 and 5 is coated with an insulating protective layer 18, which prevents a short circuit even when the address electrode comes into contact with the inclined mirror 16, as indicated by the solid line shown in FIG. 3A.

Materials of the different components that form the mirror element 1 will now be described. The mirror 16 is preferably made of a highly reflective metal, such as aluminum and gold. Part or all of the elastic hinge 13, which supports the mirror 16, is preferably made of a resilient metal, silicon, ceramics or the like (The elastic hinge 13 is composed of the root portion of the hinge on the mirror 16 side, the portion on the semiconductor wafer substrate 11 side, and the intermediate vertical portion connecting the two). The elastic hinge 13 shown in FIGS. 3A and 3B is composed of elastic material with flexibility to function as a cantilever to allow the mirror 16 to freely vibrate. The address electrodes 3 and 5 are preferably made of a conductor, such as Al, Cu, and W. The insulating layer 18 is preferably made of SiO₂, SiC or other similar substances. The semiconductor wafer substrate 11 is preferably made of Si.

Referring to FIG. 3A, a brief description will be made of how the mirror element 1 is controlled to reflect the incident light toward a predetermined projection light path (in the ON-light state).

In FIG. 3A, in the initial state in which no voltage is applied to the address electrode 3 or 5, the mirror 16 is horizontally oriented (the mirror 16′ indicated by the broken line). Application of a voltage to one of the address electrodes 3 generates a coulomb force F between the address electrode 3 and the mirror 16. When the generated Coulomb force F is greater than the resistance force of the elastic hinge 13, the mirror 16 is deflected as indicated by the solid line in FIG. 3A. As described above, by applying a voltage to one of the address electrodes 3 to deflect the mirror surface to a predetermined inclined position, the light incident on the mirror 16 is reflected toward a predetermined projection light path. When the reflected light (ON-light) is incident on the pupil of a projection lens disposed in the projection light path, a projected image is formed on a projection surface.

Referring to FIG. 3B, a brief description will be made of how the mirror element 1 is controlled not to reflect the incident light toward the projection light path (in the OFF-light state).

In FIG. 3B, using the same processes as described in FIG. 3A, a voltage is applied to the other address electrode 5 to deflect the mirror surface in a direction different from that of the ON light. The light reflected in such a direction (OFF light) will not be incident on the pupil of the projection lens, and hence will not contribute to the projected image formation.

In a projection apparatus using the micromirror device described above, the micromirror device is irradiated with illumination light produced by a light source, such as a high-pressure mercury lamp, a xenon lamp, an LED, or a laser, and the deflection direction of the mirror element is controlled as described above to project a desired image on the projection surface. In this process, however, the illumination light also impinges on portions of the micromirror device other than the mirror surfaces, so that unwanted light that does not contribute to the image formation on the projection surface is reflected and scattered. When the unwanted light enters the projection lens and reaches the projection surface, the contrast and grayscale of the projected image decreases undesirably in a significant manner.

Therefore, it is desirable to lower the reflectivity of the non-mirror portions of the micromirror device as much as possible in order to improve image quality. To this end, an absorption film containing a light-absorbing material, such as C and TiN, has been used (see U.S. Pat. Nos. 6,618,186, 6,844,959, and 7,009,745).

U.S. Pat. No. 6,618,186 describes a configuration in which at least part of the mechanism mounted on the substrate is covered with a light-absorbing film made of carbon-containing fluororesin.

Although TiN, for example, can reduce the initial reflectivity of an aluminum electrode of 90% to approximately 40%, the amount of reduction is not sufficient. On the other hand, a multi-layer coating film made of Cr/SiO or the like can be used to reduce the above reflectance to a value on the order of several percents, but fabrication of such a multi-layer film adds extra cost to the manufacturing process.

### SUMMARY OF THE INVENTION

In view of the circumstances described in the above prior art section; an object of the invention is to provide an inexpensive, micromirror device with convenient manufacturability that prevents generation of unwanted light to improve the quality of a projected image.

To achieve the above object, the micromirror device of the invention includes a particle-containing, anti-reflection layer (substantially transparent, for example) that covers at least a portion of the micromirror device other than the mirror surfaces.

The size of the particle is preferably smaller than or equal to the wavelength of the light incident on the micromirror device. Specifically the particle size is smaller than or equals to 800 nm, more preferably at least 380 nm but smaller than or equal to 800 nm.

Further, the particle is preferably made of metal, more preferably TiN.

The anti-reflection layer is preferably deposited on the semiconductor wafer substrate on which a plurality of mirrors, each having a mirror surface, are arranged, or on at least part of the package that encloses the semiconductor wafer substrate.

Further, the anti-reflection layer is preferably formed by drying a resin solution (polyimide solution, for example), or by using a sol-gel method.

### BRIEF DESCRIPTIONS OF THE DRAWINGS

The present invention will be more apparent from the following detailed descriptions in conjunction with the accompanying drawings, in which:

FIGS. 1A and 1B are functional block diagram and a top view of a portion of a micromirror array implemented as a spatial light modulator for a digital video display system of a conventional display system disclosed in a prior art patent.

FIG. 1C is a circuit diagram for showing a prior art circuit for controlling a micromirror to position at an ON and/or OFF states of a spatial light modulator.

FIG. 1D is diagram for showing the binary time intervals for a four bit gray scale.

FIG. 2 is a perspective view showing a micromirror device 10 having a plurality of mirror elements 1 arranged in a two-dimensional manner on a semiconductor wafer substrate 11.

FIG. 3A is a cross-sectional view taken along the line II-II shown in FIG. 2 (in the ON-light state).

FIG. 3B is a cross-sectional view taken along the line II-II shown in FIG. 2 (in the OFF-light state).

FIG. 4A explains how the light is reflected off a single metal particle.

FIG. 4B explains how the light is reflected off a larger number of metal particles.

FIG. 5 explains the intensity distribution image of Mie scattering caused by a particle.

FIG. 6 shows cross-sectional views of a micromirror device for schematically explaining the processes for manufacturing the micromirror device.

FIG. 7 is a cross-sectional view showing a micromirror device in which the semiconductor wafer is enclosed in a package.

FIG. 8 is a cross-sectional view of a micromirror device displaying the first variation of placement of the anti-reflection layer in the device in which the semiconductor wafer is enclosed in a package.

FIG. 9 is a cross-sectional view of a micromirror device displaying a second variation of placement of the anti-reflection layer in the device in which the semiconductor wafer is enclosed in a package.

FIG. 10 is a cross-sectional view of a micromirror device displaying a third variation of placement of the anti-reflection layer in the device in which the semiconductor wafer is enclosed in a package.

FIG. 11 is a cross-sectional view of a micromirror device displaying a fourth variation of placement of the anti-reflection layer in the device in which the semiconductor wafer is enclosed in a package.

FIG. 12 is a cross-sectional view of a micromirror device displaying a fifth variation of placement of the anti-reflection layer in the device in which the semiconductor wafer is enclosed in a package.

FIG. 13 is a cross-sectional view of a micromirror device displaying a sixth variation of placement of the anti-reflection layer in the device in which the semiconductor wafer is enclosed in a package.

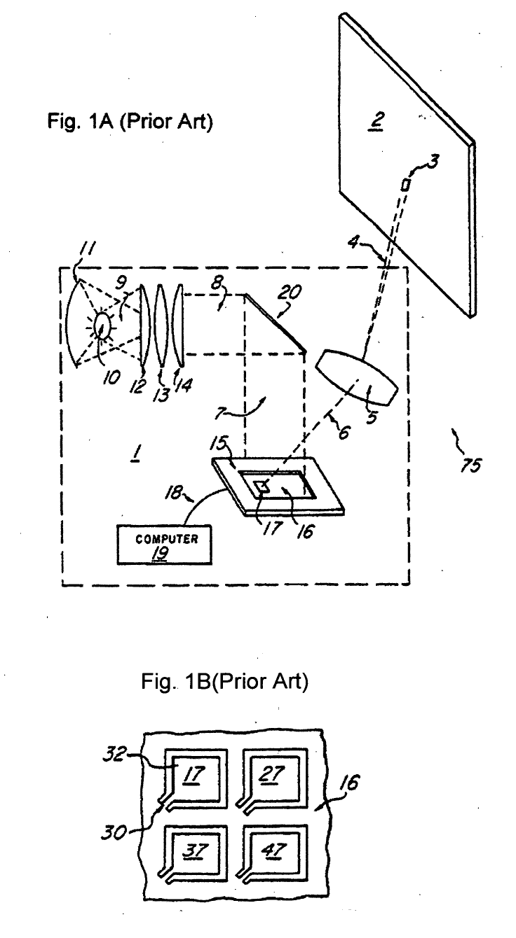

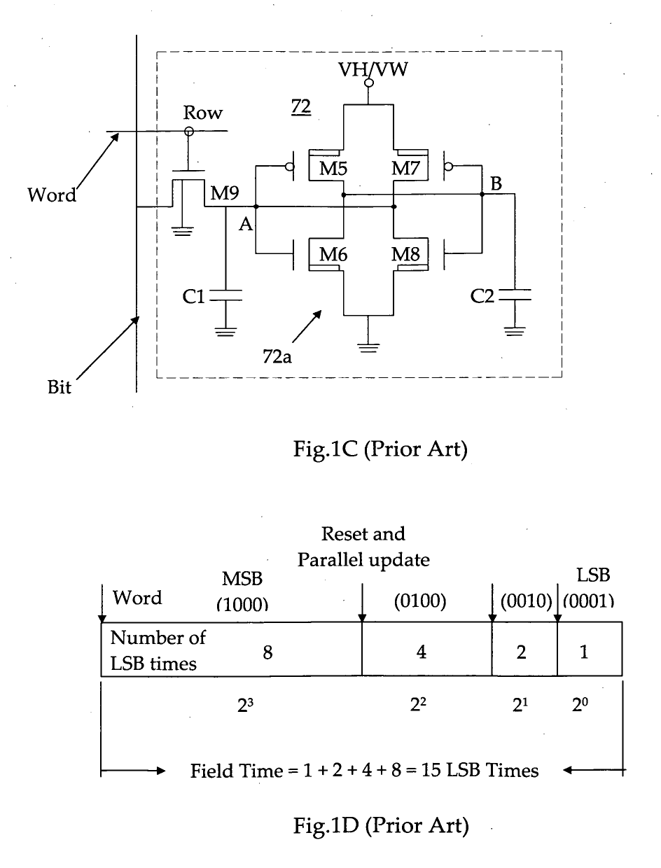

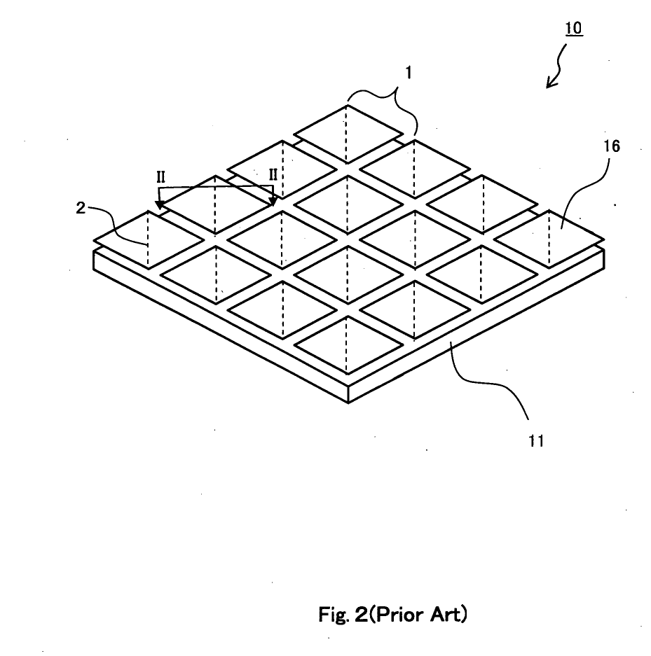

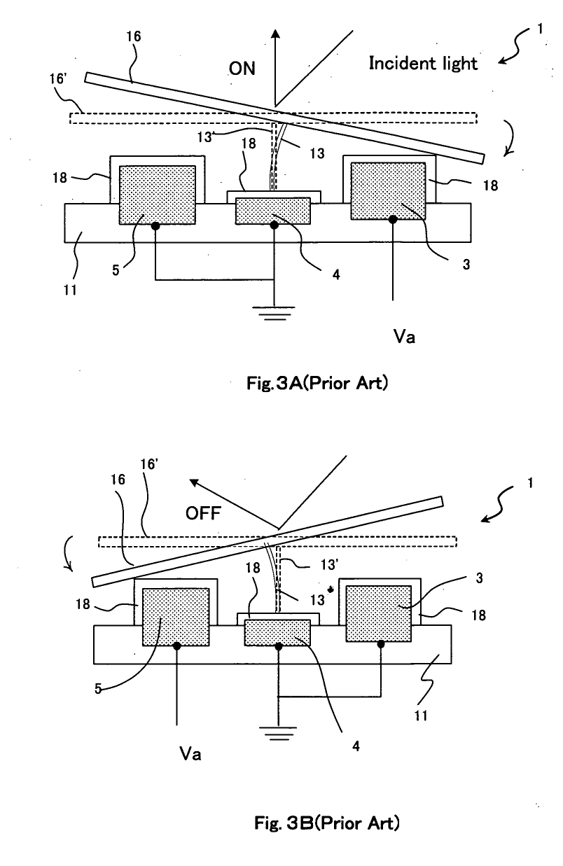

### DESCRIPTION OF THE PREFERRED EMBODIMENTS

When light is incident on the boundary between different media, part of the light is reflected off the boundary, whereas the other portion passes through the boundary. Part of the light that has passed through is attenuated, and such attenuation is called light absorption phenomenon.

Any metal typically has higher reflectivity than that of any transparent material, such as SiO₂. The reflectivity of a typical metal approximately ranges from 30 to 90%.

The complex refractive index n of a light-absorbing material is expressed as follows:

n=N−ik

where N denotes the real part of the refractive index, and k denotes the imaginary part, which is called an attenuation coefficient representing absorption. It is noted that the greater the attenuation coefficient, the higher the reflectivity. That is, it is known that light that has entered a highly reflective material is rapidly attenuated. For transparent materials, such as SiO₂ and TiO₂, k is zero, whereas for metals, k typically ranges from 0.5 to 5.

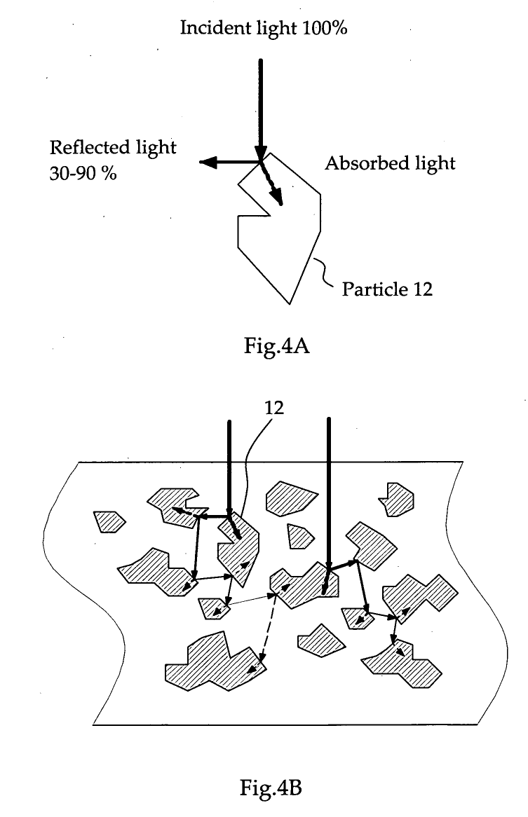

Now, consider a case where a large number of metal particles 12 shown in FIG. 4A are present as shown in FIG. 4B. When light is incident on the metal particles, one particle reflects 30 to 90% of the light and the remainder is absorbed by that particle. The light reflected off that particle will be incident on another particle. The reflection and absorption will occur in this other particle in the same manner. In this way, the light incident on these particles is repeatedly reflected off other nearby particles and eventually absorbed, so that the particles as a whole has absorbed the light and appears dark. This phenomenon also explains the observable fact that finely ground metal particles appear black in color.

When the diameter (size) of the particle is further reduced to a value on the order of the wavelength of light, the incident light is scattered according to Mie scattering instead of non-selective scattering, in which light having various wavelengths is scattered. When the diameter (size) of the particle is still further reduced to a value smaller than or equal to the wavelength of light, the light is scattered according to Rayleigh scattering, in which backscattered light (the light scattered back in the direction of incidence) decreases. That is, in a reflective spatial light modulator, an anti-reflection layer containing metal particles of this size effectively decreases the scattered light toward the projection light path.

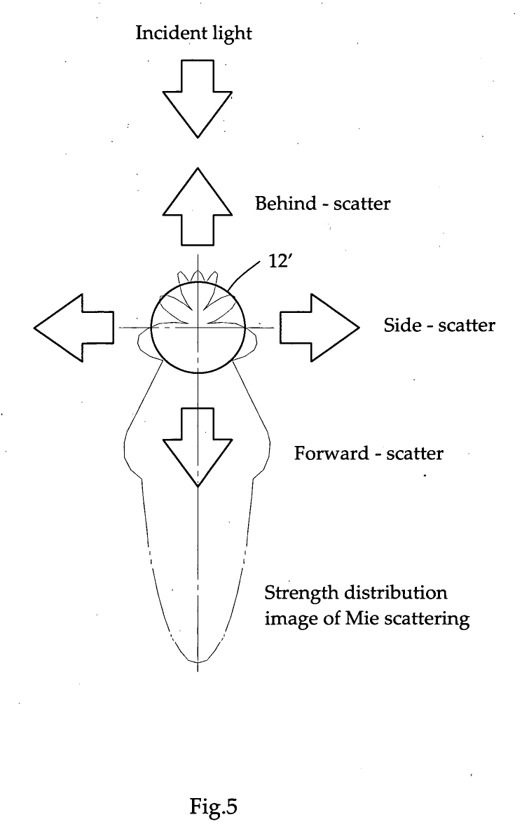

FIG. 5 explains the intensity distribution image of Mie scattering caused by a particle. In FIG. 5, the size of a particle 12′ is on the order of the wavelength of the incident light. It is noted that the particle 12′ is drawn as a sphere for convenience.

Most of the light incident on the particle 12′ becomes forward scattered light. The amount of side-scattered light is much smaller than that of the forward-scattered light, and the amount of backscattered light (the light scattered back in the direction of incidence) is smaller even than that of the side-scattered light. Since the amount of the scattered light directed toward the illumination light path is smaller, use of the particles 12′ shown in FIG. 5, each having a size on the order of the wavelength of the incident light, can effectively prevent reflection of unwanted light that does not contribute to image formation toward the projection light path.

In order to have the forward-scattered light from one particle be absorbed by an adjacent particle, the particles are desirably spaced apart from each other by a small distance, as shown in FIG. 4B. To this end, in a reflective spatial light modulator (micromirror device) on which visible light is incident, it is conceivable to embed particles in a transparent medium, each particle having a size smaller than or equal to 800 nm, preferably ranging from 380 to 800 nm (the visible light spectrum), or a size equal to or smaller than the wavelength of the incident light.

Manufacturing the anti-reflection layer may involve depositing a solution containing the particles described above using any of various application methods, such as spin coating, spraying, or dipping. The solution may also be deposited using any of various printing methods, such as screen-printing, inkjet printing, and spin coating. Another effective method of forming an anti-reflection layer involves solidifying a solution of resin, such as polyimide containing the above particles [[NOTE: I'm not sure if they are talking about two different things in this paragraph 1.) making the solution containing the particles and 2.) depositing this solution onto the device or just one process]]. Polyimide is preferably used in this application because, as compared to other organic or polymeric materials, it exhibits excellent heat resistance, chemical stability, and mechanical strength. Hence, it will be less sensitive to the manufacturing processes. Furthermore, an anti-reflection layer can be formed by converting a transparent solution, composed of, for example, SiO2, in which particles are dispersed (sol) into a dried gel.

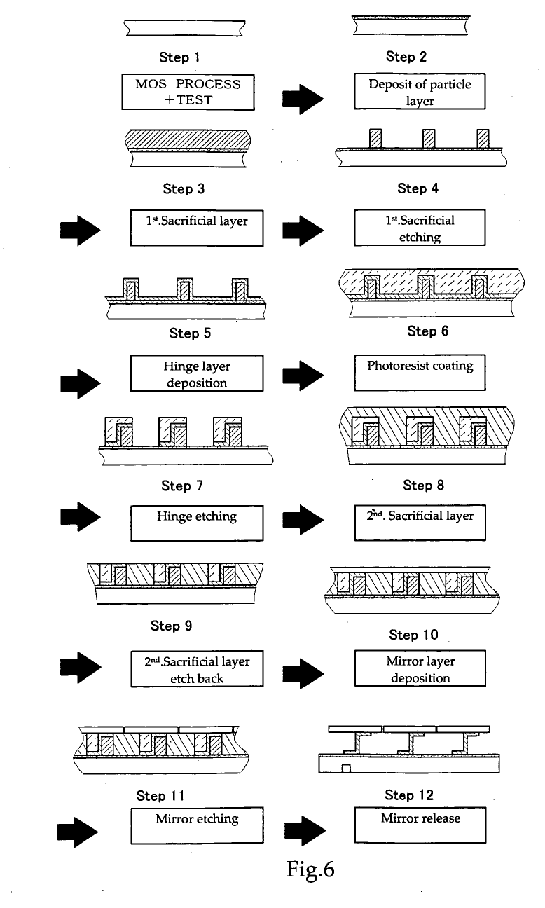

As an example of the application of the invention, processes for manufacturing the micromirror device with such an anti-reflection layer will be schematically described below. FIG. 6 shows cross-sectional views of the micromirror device as it undergoes the processes for manufacturing the micromirror device with the anti-reflection layer described in the invention.

In step 1 of FIG. 6, a drive circuit (not shown) for driving and controlling a mirror, which will be provided later, and address electrodes (not shown) connected to the drive circuit are formed on a semiconductor wafer substrate 21. Then, the drive circuit formed on the semiconductor wafer substrate 21 undergoes a test to check if the drive circuit is normally operated and the address electrodes are electrically connected. If there is no failure in the drive circuit or the electrodes, manufacturing proceeds to step 2.

In step 2 of FIG. 6, an anti-reflection layer 22 containing particles is deposited on the semiconductor wafer substrate 21 on which the drive circuit and the address electrodes (not shown) have been formed. The particles in the anti-reflection layer 22 are made of metal, such as aluminum, germanium, and titanium, or nitrides or oxides thereof, and the diameter (size) of the particle is preferably equal to or smaller than the wavelength of visible light.

Such particles can be obtained by using various methods, including mechanical grinding, chemical methods (such as atomization in which melted metal is sprayed into powder, reduction, and electrolyzation), and physical/chemical powdering, such as a carbonyl process. The particles, obtained by any of the above methods, are mixed in the SOG (Spin On Glass), which is then coated on the semiconductor wafer substrate 21 obtained in step 1. It is noted that the anti-reflection layer 22 can be made of a particle-containing transparent resin, such as the polyimide described above.

In this process, depending on the type of a first sacrificial layer 23 (to be described later), which will eventually be etched away, or the type of the etchant used in the etching, an etching stopper layer (not shown) may further be deposited on the anti-reflection layer 22 in order to prevent the etching, which will be described later, from removing the anti-reflection layer 22 along with the sacrificial layer.

In step 3 of FIG. 6, the first sacrificial layer 23 is further deposited on the anti-reflection layer 22 on the semiconductor wafer substrate 21 on which the drive circuit and the electrodes have been formed. The first sacrificial layer 23 is used to form a mirror surface, which will be formed in a later step, with a gap between the mirror surface and the semiconductor wafer substrate 21. In this embodiment, the thickness of the first sacrificial layer 23 determines the height of the elastic hinge 24′ (to be described later), which will support the mirror.

The first sacrificial layer 23 in this embodiment may be deposited on the semiconductor wafer substrate 21 by using, for example, a method called chemical vapor deposition (CVD). Chemical vapor deposition is a method for depositing a film on a wafer. The wafer is placed in a chamber and gaseous raw material from which the sacrificial layer will be formed is supplied and a chemical catalyst reaction is used.

In step 4 of FIG. 6, part of the first sacrificial layer 23 is etched away so that column-like portions 23′ are left, each of the column-like portions 23′ will determine the height and shape of the elastic hinge 24′, which will be formed in a later process.

In step 5 of FIG. 6, an elastic layer 24 is deposited on the anti-reflection layer 22 and the column-like portions 23′. The elastic layer 24 includes a connection portion (not shown) to be electrically connected to the semiconductor wafer substrate 21. In this embodiment, the elastic layer 24 is preferably deposited in such a way that it covers the surfaces of the column-like portions 23′ because the elastic layer 24 will be etched to form the elastic hinge 24′ that supports the mirror. The thickness of the elastic layer 24 that covers the column-like portions 23′ determines the thickness of the elastic hinge 24′. The elastic layer 24 is preferably made of Si or other similar substance.

In step 6 of FIG. 6, a layer of photoresist 25 is further deposited on the elastic layer 24. The photoresist 25 is preferably deposited in such a way that its upper surface is higher than the elastic layer 24 deposited on the column-like portions 23′.

In step 7 of FIG. 6, a mask that transfers a desired structural shape is used to expose the photoresist 25 to light, and then the elastic layer 24 deposited on the semiconductor wafer substrate 21 is etched away so as to provide the desired structural shape. Specifically, the etching in this step divides the elastic layer 24 and the photoresist 25, for example, into box shapes, each including one column-like portion 23′, so that the deposited elastic layer 24 forms the elastic hinge 24′ for each mirror element. The structure described above is thus formed of the column-like portion 23′, the divided elastic hinge 24′, and the photoresist 25′. In this process, according to the desired shape of the elastic hinge 24′, the elastic layer 24 is preferably divided in such a way that it lies flush against the following three surfaces: the upper surface of the column-like portion 23′, one of the sides of the column-like portion 23′ (one of the four sides when the column-like portion 23′ is a rectangular column), and the upper surface of the anti-reflection layer 22.

In step 8 of FIG. 6, a second sacrificial layer 26 is further deposited. The second sacrificial layer 26 is deposited in such a way that its upper surface is at least higher than the upper surface of the elastic hinge 24′, which is located on the column-like portion 23′.

In step 9 of FIG. 6, the divided photoresist 25′ and the deposited second sacrificial layer 26 are polished until the upper surface of the elastic hinge 24′ is exposed.

In step 10 of FIG. 6, a mirror layer 27 is deposited on the upper surfaces of the exposed elastic hinge 24′ and the photoresist 25′. The mirror layer 27 in this embodiment is made of, for example, a highly reflective material such as aluminum, gold, or silver. To strongly bond the mirror layer 27 to the elastic hinge 24′ that supports the mirror layer 27, or to prevent the mirror (mirror layer 27) from adhering to a stopper (not shown) that will come into contact with the mirror when the mirror is deflected, a mirror support layer made of a material different from that of the mirror is preferably formed between the mirror layer 27 and the elastic hinge 24′. The mirror support layer is preferably made of titanium and tungsten.

In step 11 of FIG. 6, another layer of photoresist (not shown) is applied onto the mirror layer 27, and a mask is used to expose the photoresist to light to form a mirror pattern. Then, etching is carried out to divide the mirror layer 27 into individual mirrors 27′. The shape of each of the mirrors 27′ is thus formed. Specifically, a gap is formed between adjacent mirrors 27′ so that they will not come into contact with each other, and, at the same time, the mirror surface of each of the mirrors 27′ is formed into the desired shape.

In step 12 of FIG. 6, etchant is used to remove the column-like portions 23′, the photoresist 25′, and the second sacrificial layer 26 to make the elastic hinge 24′ and the mirror 27 protected by these layers deflectable. Recesses 21a are preferably formed in the lower surface of the semiconductor wafer substrate 21. The recess 21a will be used to position the semiconductor wafer substrate 21 with respect to a package, which will be described later, in which the semiconductor wafer substrate 21 is enclosed.

The elastic hinge 24′ and the mirror 27′ thus formed on the semiconductor wafer substrate 21 (anti-reflection layer 22) is now deflectable by using the drive circuit and the electrodes (not shown). Although the actual manufacturing method involves several other processes, such as a process for subdividing the whole mirror device into individual mirror devices (dicing process), a process for packaging each of the divided mirror devices, and an anti-stiction process for preventing the movable portion (primarily the mirror 27) from adhering to other components (such as the stopper for the mirror 27), these descriptions will be omitted.

In the thus configured micromirror device, the illumination light incident on the portions of the device other than the mirror surfaces, in this embodiment on the semiconductor wafer substrate 21 that does not contribute to image formation, is absorbed by the anti-reflection layer 22 as described above, so that the illumination light will not be reflected toward the projection light path and hence the quality of the projected image will not be degraded.

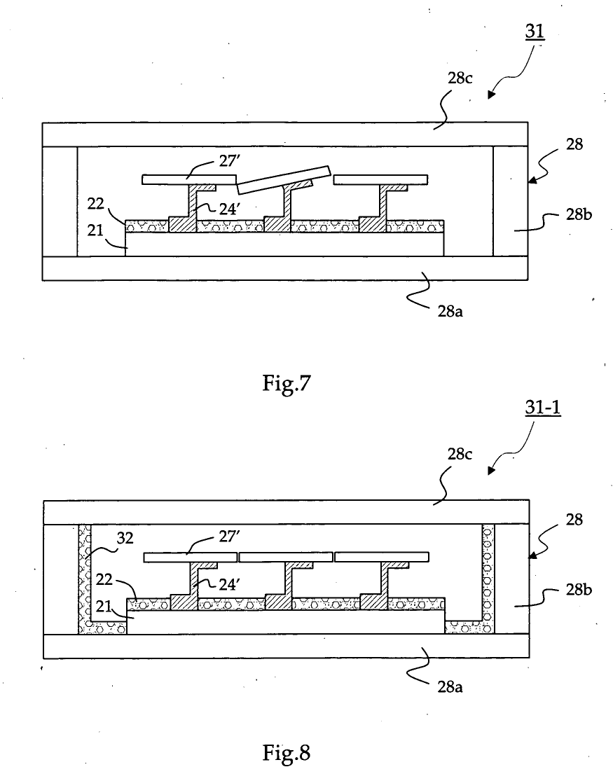

FIG. 7 is a cross-sectional view showing a micromirror device according to this embodiment in which the semiconductor wafer is enclosed in a package.

In FIG. 7, the semiconductor wafer substrate 21 on which the mirrors 27′, the elastic hinges 24′, and the anti-reflection layer 22 have been formed is enclosed in a package 28 to form a micromirror device 31. The package 28 includes a bottom plate 28a on which the semiconductor wafer substrate 21 is mounted, side plates 28b that form the sides of the package 28, and a cover glass 28c that is placed on the side plates 28b and transmits the incident light to the mirrors 27′. The semiconductor wafer substrate 21 is obtained by cutting the whole of the micromirror devices that have undergone the manufacturing processes in FIG. 6, and only three sets of the mirror 27′ and the elastic hinge 24′ are illustrated for the sake of convenience. It is noted, however, that a large number of mirror elements (each element includes not only the mirror 27′ and the elastic hinge 24′ but also the address electrodes) are typically included in a micromirror device 31.

FIGS. 8 to 13 are cross-sectional views showing micromirror devices according to first to sixth variations of the embodiment described above in which the semiconductor wafer is enclosed in the package.

In the micromirror device 31-1 shown in FIG. 8, particle-containing anti-reflection layers 32 are deposited on part of the bottom plate 28a, where the semiconductor wafer substrate 21 is not mounted, and on the side-plates 28b of the micromirror device 31 shown in FIG. 7. The anti-reflection layer 32 is formed by first dipping the package in a solution into which a metal or an oxide or nitride thereof has been mixed and then drying the package. In this process, the portions of the device where light absorption through the anti-reflection layer 32 is not desired may be masked, so that the masked portion does not undergo the above process. To carry out such selective coating, the anti-reflection layer 32 can be more efficiently fabricated by using a printing method, such as screen-printing or inkjet printing.

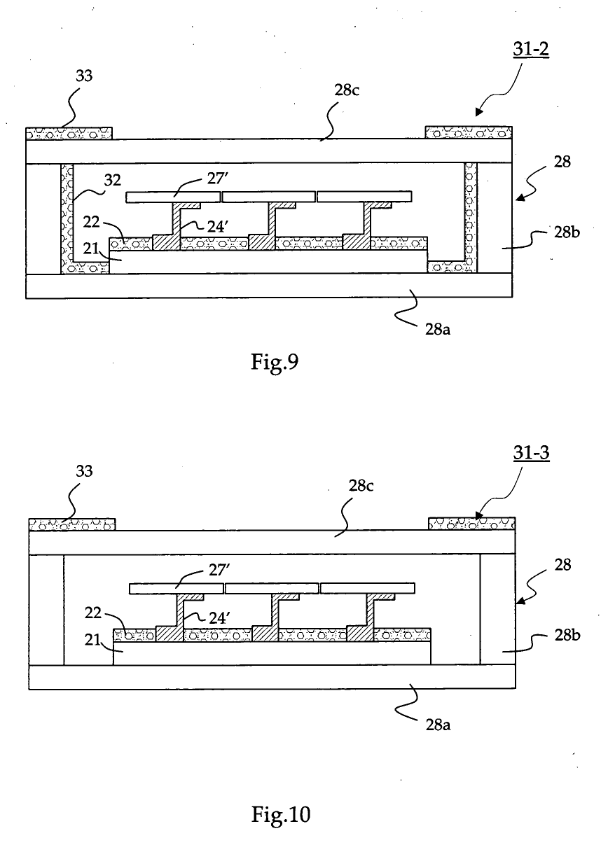

In the micromirror device 31-2 shown in FIG. 9, in addition to the anti-reflection layer 32 in the micromirror device 31-1 shown in FIG. 8, an anti-reflection layer 33 is deposited on the periphery of the cover glass 28c, the portion through which the light to be incident on the mirrors 27′ does not pass.

The micromirror device 31-3 shown in FIG. 10 differs from the micromirror device 31-2 shown in FIG. 9 in that the anti-reflection layer 32 is not deposited on the bottom plate, 28a, where the semiconductor wafer substrate 21 is not mounted, nor is it deposited on the side plates 28b. The anti-reflection layer 33 is deposited on part of the package 28, the periphery of the cover glass 28c through which the light to be incident on the mirrors 27′ does not pass.

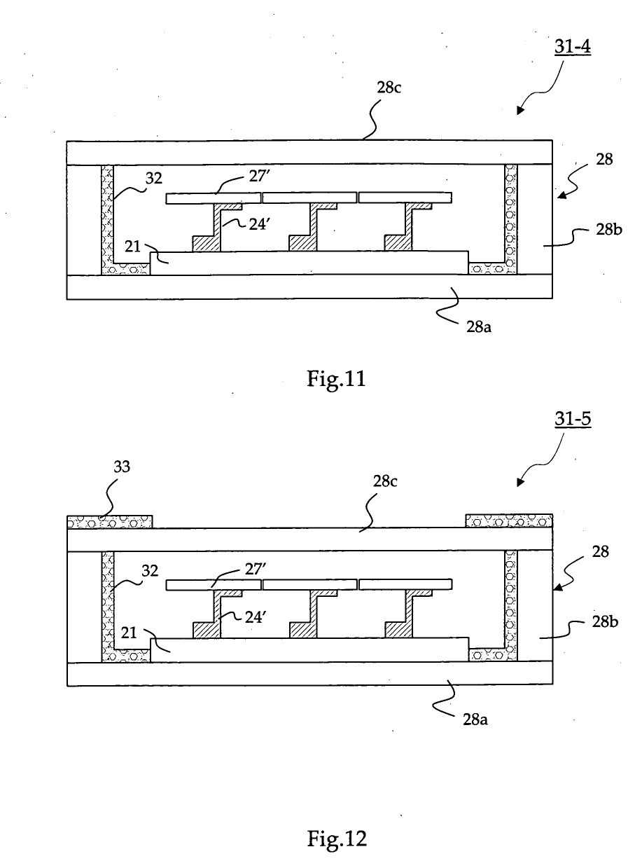

Micromirror devices 314, 31-5, and 31-6 shown in FIGS. 11 to 13 differ from the micromirror devices 31-1, 31-2, and 31-3 shown in FIGS. 8 to 10, respectively, in that no anti-reflection layer 22 is deposited on the semiconductor wafer substrate 21.

In the micromirror device 31-4 shown in FIG. 11, no anti-reflection layer 22 is deposited on the semiconductor wafer substrate 21. The anti-reflection layer 32 is deposited only on part of the bottom plate 28a, where the semiconductor wafer substrate 21 is not mounted, and on the side-plates 28b.

In the micromirror device 31-5 shown in FIG. 12, no anti-reflection layer 22 is deposited on the semiconductor wafer substrate 21. The anti-reflection layer 32 is deposited on part of the bottom plate 28a, where the semiconductor wafer substrate 21 is not mounted, and on the side-plates 28b. The anti-reflection layer 33 is also deposited on the portion of the cover glass 28c through which the light to be incident on the mirrors 27′ does not pass.

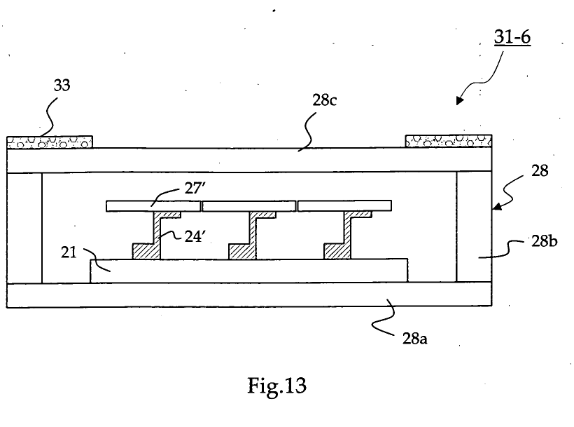

In the micromirror device 31-6 shown in FIG. 13, no anti-reflection layer 22 is deposited on the semiconductor wafer substrate 21, but the anti-reflection layer 33 is deposited on the portion of the cover glass 28c through which the light to be incident on the mirrors 27′ does not pass.

Further, when the bottom plate 28a is formed of an optically transparent substance, the anti-reflection layer may be formed on the outer surface of the package according to the methods of the invention.

The anti-reflection layers 32 and/or 33 deposited on the package 28 of each of the micromirror devices 31 shown in FIGS. 8 to 13 is preferably formed by drying a resin solution, such as a polyimide solution, or by using a sol-gel method, the method by which the anti-reflection layer 22 is deposited on the semiconductor wafer substrate 21.

In the above embodiment and first to sixth variations thereof, each of the micromirror devices 31 has particles (anti-reflection layers 22, 32, and/or 33) that cover at least a portion of the device other than the mirror surfaces 27′. Therefore, unwanted light can be absorbed in a simple configuration, so that the quality of a projected image can be improved by implementing an inexpensive manufacturing processes with the device configuration has a more convenient manufacturability.

Further, by reducing the size of the particle to a value smaller than or equal to the wavelength of light (visible light, for example) incident on the micromirror device 31, the light incident on the particles is scattered according to Mie scattering or Rayleigh scattering, so that the amount of backscattered light (the light scattered back in the direction of incidence) is reduced. Preferably, the size of the particle is reduced to 800 nm or smaller, preferably at least 380 nm but smaller than or equal to 800 nm. In this way, the amount of unwanted light that disadvantageously contributes to projected image formation can be reduced. The quality of a projected image can thus be improved. [[NOTE: they originally had two paragraphs that were identical except for the specification of the particle size. I think that may be redundant, so I condensed it into one paragraph]]

Further, by using particles made of metal, it is expected that the particles will serve as an electromagnetic, electrostatic shield unlike the conventional light-absorbing layer made of an insulating material. The device can therefore be operated in a stable manner without being affected by an external noise environment or affecting the external environment.

Moreover, by depositing the particles or the anti-reflection layers 22, 32, and 33 on the semiconductor wafer substrate 21 and/or on the package 28, unwanted light can be absorbed at desired locations, so that required quality of a projected image can be effectively achieved.

Further, by forming the anti-reflection layers 22, 32, and 33 by solidifying a resin solution, such as a polyimide solution, or by using a sol-gel method, the particles can effectively absorb unwanted light, so that the quality of a projected image can be further improved.

We claim:

1. A micromirror device comprising:
a particle-containing anti-reflection layer covering at least a portion of the micromirror device other than a mirror surface.

2. The micromirror device according to claim 1,
wherein a size of a particle in said particle-containing anti-reflection layer is smaller than or equal to the wavelength of light incident on the micromirror device.

3. The micromirror device according to claim 1,
wherein a size of a particle in said particle-containing anti-reflection layer is smaller than or equal to 800 nm.

4. The micromirror device according to claim 3, wherein
a size of a particle in said particle-containing anti-reflection layer is at least 380 nm but smaller than or equal to 800 nm.

5. The micromirror device according to claim 1, wherein:
the particle-containing anti-reflection layer containing metal particles.

6. The micromirror device according to claim 1, wherein:
the particle-containing anti-reflection layer containing TiN particles.

7. The micromirror device according to claim 1 further comprising:
a semiconductor substrate having a plurality of mirrors arranged thereon, each of the plurality of mirrors having a mirror surface,
wherein the anti-reflection layer is disposed on the semiconductor substrate.

8. The micromirror device according to claim 1 further comprising:
a semiconductor wafer substrate having a plurality of mirrors arranged thereon, each of the plurality of mirrors having a mirror surface; and
a package enclosing the semiconductor substrate,
wherein the anti-reflection layer is disposed on at least a portion of the package.

9. The micromirror device according to claim 1, wherein:
the anti-reflection layer comprising a resin layer formed by drying a resin solution.

10. The micromirror device according to claim 1, wherein:
the anti-reflection layer comprising a layer of polyimide resin formed by drying a polyimide solution.

11. The micromirror device according to claim 1, wherein:
the anti-reflection layer comprising a sol-gel layer formed by using a sol-gel method.
